(19) United States
(12) Patent Application Publication
(10) Pub. No.: US 2003/0059089 A1
(43) Pub. Date: Mar. 27, 2003

(54) Block matching at the fractional pixel level for motion estimation

(76) Inventors: James E. Quinlan, Marlboro, MA (US); Priya N. Vaidya, Belchertown, MA (US); Nigel Paver, Austin, TX (US)

Correspondence Address: Timothy N. Trop, TROP, PRUNER & HU, P.C., 8554 KATY FWY, STE 100, HOUSTON, TX, 77024-1805, US

(21) Appl. No.: 09/962,905

(22) Filed: Sep. 25, 2001

(51) Int. Cl. H04N 7/12; G06K 9/00

(52) U.S. Cl. 382/107; 375/240.17; 375/240.16; 375/240.12; 375/240.24

(57) ABSTRACT

A row-wise technique may be utilized for determining a fractional matching block in a motion estimation vector algorithm. By interpolating and calculating a sum of absolute differences on a row-wise basis, a more efficient algorithm may be implemented. On a row-by-row basis, the corresponding interpolated values are updated and those values, once updated, may be compared to determine the best match among the potential fractional matching blocks. As a result, a fractional matching block may be identified to determine the motion vector to a greater degree of accuracy.

### BACKGROUND

This invention relates generally to algorithms for compressing information such as successive video frames.

Successive video information may be compressed to reduce the amount of bandwidth needed to transmit the frames from one processor-based system to another. Compression may be achieved by reducing the information of successive frames to a single motion vector combined with any necessary corrective residual values. For motion estimation, block matching methods are most popular due to their low computational complexity.

In block matching, a current frame is divided into a number of small rectangular blocks. For each block of the current frame, a motion vector [u,v] is obtained by finding the displaced coordinate of a matching block within the search window of a reference frame. The matching block may be located by performing a running sum of absolute differences (SAD), a sum of differences squared or other matching algorithms, on each corresponding pixel of the current and reference blocks.

The picture quality requirements of current video coder/decoders necessitate resolution of motion vectors to fractions of a pixel, commonly to one half pixel. The calculation of fractional pixel values may be accomplished using bilinear interpolation. Block search algorithms generally locate the best matching block within the resolution of one pixel and then, in a separate subsequent step, calculate the best possible block to within the fractional resolution. This final step may be accomplished by evaluating the sum of absolute differences of all eight possible fractional blocks and then selecting the best choice from these eight fractional blocks in the original full pixel block.

Conventionally, the technique for refining the motion vector to one half pixel accuracy includes computing, using bilinear interpolation, all the pixel values that lay on the half pixel boundaries. The sum of absolute differences or some other matching algorithm value is then computed for all eight half pixel boundary points with respect to the reference block. The points for the reference block are then compared to the same points in the current block. The minimum point is the half pixel output accurate motion vector.

While these techniques work well, there is a need for faster and more efficient techniques for determining fractional matching blocks.

### BRIEF DESCRIPTION OF THE DRAWINGS

FIG. 1 is a depiction of the matching algorithm in accordance with one embodiment of the present invention;

FIG. 2 is a depiction of a portion of the current block in accordance with one embodiment of the present invention;

FIG. 3 is a depiction of a portion of the current block shown in FIG. 2;

FIG. 4 is a depiction of a portion of a reference block corresponding to the portion of the current block shown in FIG. 3;

FIG. 5 is a block matching algorithm is accordance with one embodiment of the present invention; and

FIG. 6 is a depiction of a processor-based system in accordance with one embodiment of the present invention.

### DETAILED DESCRIPTION

In accordance with one embodiment of the present invention, an algorithm simultaneously computes a sum of absolute differences of eight N×N blocks and the fractional (e.g., one half) pixel interpolations all in a single pass. This single pass algorithm may involve fetching the rows of the center block and matching block one after another. In some embodiments the algorithm may eliminate numerous redundant calculations and memory references that lead to decreased speed and increased memory requests. Thus, in some embodiments, the present invention may be faster and more memory efficient. In other embodiments, other matching algorithms may be used.

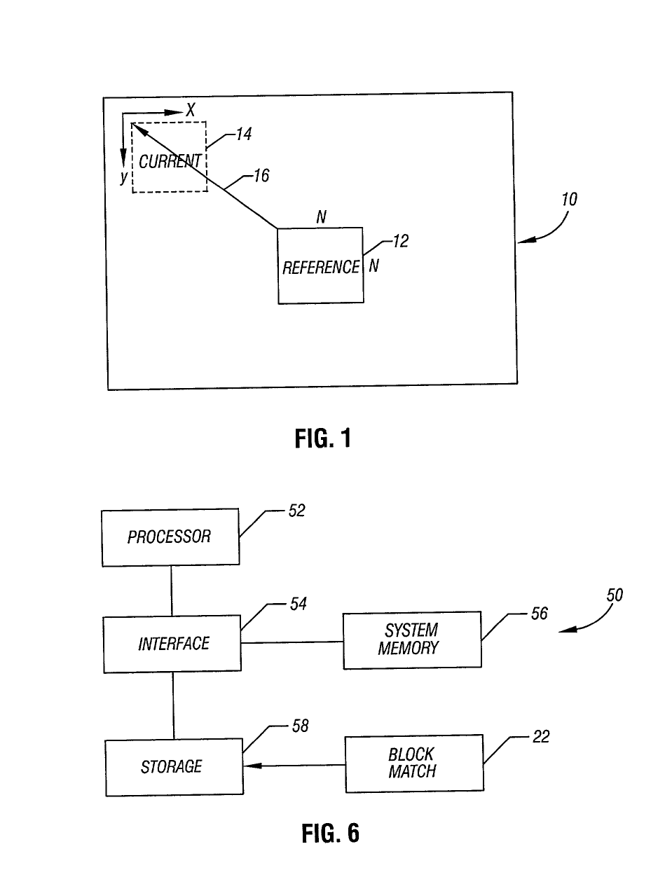

Referring to FIG. 1, a current frame 10 may be divided into rectangular blocks such as the block 14. Each block 14 of the current frame 10 defines a motion vector 16 that is determined by finding the displaced coordinate of a matching block within the search window 10 of the reference frame 12. The matching block is located by performing a matching algorithm on each of the pixels of the current and reference blocks. Thus, the motion vector defines the direction of movement of the reference frame 12 having located a corresponding block in the current frame as indicated at 16.

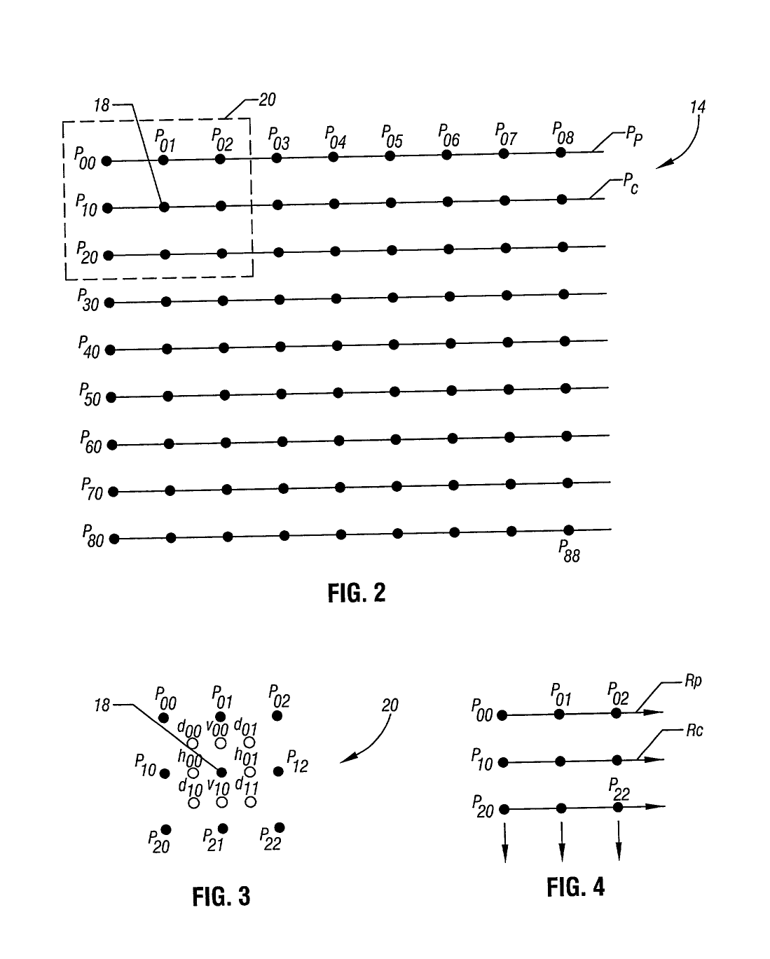

Referring to FIG. 2, a portion of a N×N candidate block may include, in one embodiment, eight points or in another embodiment, sixteen points, as two examples. Each actual pixel P may be assigned a corresponding pixel number indicating its row and column. FIG. 3 shows an enlarged depiction of the current block 14 portion 20. FIG. 4 shows the corresponding portion of the portion 20 in the reference block 12.

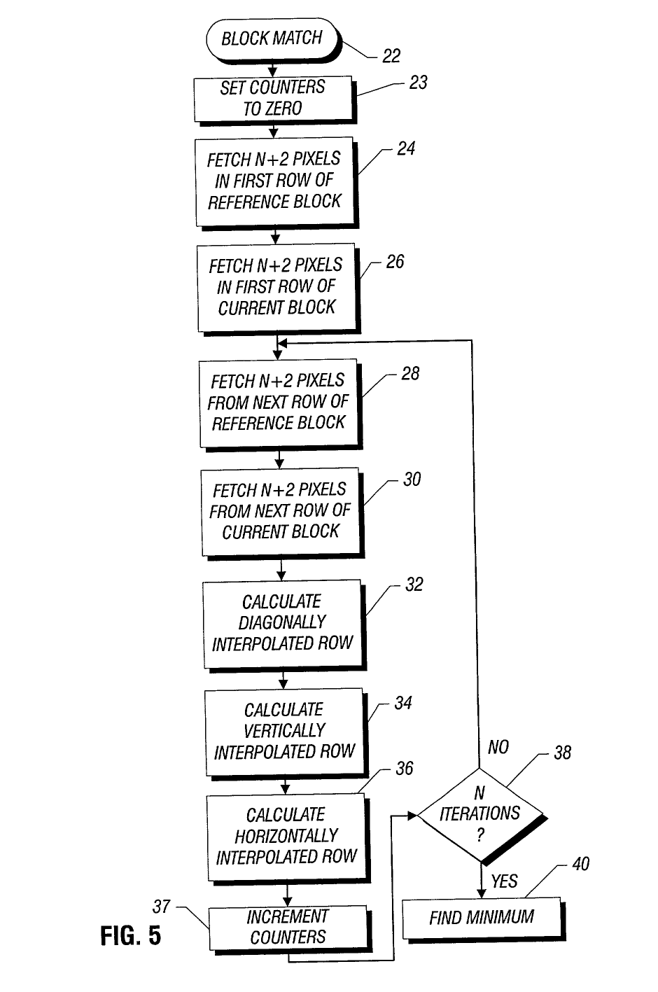

Referring to FIG. 5, the block matching algorithm 22 may initialize matching algorithm values to store sum of absolute differences or other matching algorithm values. In an embodiment using one half pixel resolution, eight values are initialized. A group of eight accumulators are set to zero as indicated in block 23. As indicated in block 24, N+2 pixels are fetched from the first row of the reference block 12. The extra pixels are needed in order to determine half pixels on each end of the row. Next, as indicated in block 26, N+2 pixels are fetched from the first row of the current block (Pₚ).

In a first iteration, N+2 pixels may be fetched from the next row of the reference block (R_{c}) as indicated in block 28. Then N+2 pixels may be fetched from the next row of the current block (P_{c}) as indicated in block 30. The diagonally interpolated row values corresponding to d₀₀, d₀₁, d₁₀ and d₁₁ may be determined. The diagonally interpolated values may be calculated for example by extending the equation

d₀₀=(P₀₀+P₀₁+P₁₀+P₁₁)/4.

As indicated in FIG. 3, the four diagonally situated rows are astride the center pixel 18. Corresponding half pixels may be determined for every other point indicated in FIG. 2. After the interpolation is complete, the corresponding sums of absolute differences are calculated for the diagonally interpolated rows (block 32). These values are then used to update four sum of difference variables of the eight variables initialized at the beginning of the algorithm.

Next, as indicated at block 34, the vertically interpolated rows corresponding to the points v₀₀, v₁₀ are determined as are the corresponding sum of absolute differences for those rows. The vertically interpolated values may be determined by averaging two vertically displaced values or, for example, v₀₀=(P₀₁+P₁₁)/2. Then the appropriate two variables of the eight initialized in the beginning are updated with those values.

Generally, the horizontally interpolated rows are calculated corresponding to the values h₀₀, h₀₁ (block 36). Corresponding sum of absolute differences are calculated for those rows. Again the appropriate SAD variables, in this case two variables, are updated with the new values. The set of eight accumulators are incremented as indicated in block 37. The first and last iteration may involve partial accumulation because these iterations involve an edge or boundary.

The iterations continue until an iteration has been completed as determined at diamond 38. Once the iterations have completed the entire reference and current blocks, the minimum of the eight SAD variables is identified (block 40). The pointer to the minimum is the address to the matching block for the motion vector.

In accordance with some embodiments, a one pass solution may be utilized for determining fractional matching blocks. While an embodiment has been described in which the fractional block is a half pixel block, the principles explained herein can be applied to any fractional block matching algorithm. The one pass solution may calculate the sum of the absolute differences and the interpolations all in one pass in order to achieve fractional motion estimation. Existing techniques may utilize multiple passes on the image data, causing those techniques to be slower and increasing the needed bandwidth.

Finally, referring to FIG. 6, the block matching algorithm 22 may be stored on a storage 58 of a processor-based system 50. That system 50 may include a processor 52 coupled to an interface 54. The interface 54, in one embodiment, may be coupled to system memory 56 and a storage 58. Of course, the present invention may be implemented in a wide range of computer architectures.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
calculating an interpolated row of both reference and current blocks;
calculating at least one additional interpolated row corresponding to a reference and a current block; and
determining the minimum interpolated values.

2. The method of claim 1 wherein said minimum interpolated values are determined in one pass.

3. The method of claim 1 including fetching pixels in a first row of a reference block and fetching pixels in a first row of a current block.

4. The method of claim 3 including fetching pixels from the next row of the reference and current blocks.

5. The method of claim 4 including calculating a diagonally interpolated row.

6. The method of claim 5 including calculating a vertically interpolated row.

7. The method of claim 6 including calculating a horizontally interpolated row.

8. The method of claim 1 including calculating a sum of absolute differences.

9. The method of claim 8 including determining the minimum of the sum of absolute differences.

10. The method of claim 1 including determining a half pixel matching block.

11. An article comprising a medium storing instructions that enable a processor-based system to:
calculate an interpolated row of both reference and current blocks;
calculate at least one additional interpolated row corresponding to a reference and a current block; and
determine the minimum interpolated values.

12. The article of claim 11 further storing instructions that enable the processor-based system to determine the minimum interpolated values in one pass.

13. The article of claim 11 further storing instructions that enable the processor-based system to fetch pixels in a first row of a reference block and fetch pixels in a first row of a current block.

14. The article of claim 13 further storing instructions that enable the processor-based system to fetch pixels from the next row of the reference and current blocks.

15. The article of claim 14 further storing instructions that enable the processor-based system to calculate a diagonally interpolated row.

16. The article of claim 15 further storing instructions that enable the processor-based system to calculate a vertically interpolated row.

17. The article of claim 16 further storing instructions that enable the processor-based system to calculate a horizontally interpolated row.

18. The article of claim 11 further storing instructions that enable the processor-based system to calculate a sum of absolute differences.

19. The article of claim 18 further storing instructions that enable the processor-based system to determine the minimum of the sum of absolute differences.

20. The article of claim 11 further storing instructions that enable the processor-based system to determine a half pixel matching block.

21. A system comprising:
a processor;
a storage coupled to said processor storing instructions that enable the processor to:
calculate an interpolated row of both reference and current blocks;
calculate at least one additional interpolated row corresponding to a reference and a current block; and
determine the minimum interpolated values.

22. The system of claim 21 wherein said storage stores instructions that enable the processor to determine the minimum interpolated values in one pass.

23. The system of claim 21 wherein said storage stores instructions that enable the processor to fetch pixels in a first row of a reference block and fetch pixels in a first row of a current block.

24. The system of claim 23 wherein said storage stores instructions that enable the processor to fetch pixels from the next row of the reference and current blocks.

25. The system of claim 24 wherein said storage stores instructions that enable the processor to calculate a diagonally interpolated row.

26. The system of claim 25 wherein said storage stores instructions that enable the processor to calculate a vertically interpolated row.

27. The system of claim 26 wherein said storage stores instructions that enable the processor to calculate a horizontally interpolated row.

28. The system of claim 21 wherein said storage stores instructions that enable the processor to calculate a sum of absolute differences.

29. The system of claim 28 wherein said storage stores instructions that enable the processor to determine the minimum of the sum of absolute differences.

30. The system of claim 21 wherein said storage stores instructions that enable the processor to determine a half pixel matching block.
